(19) United States
(12) Patent Application Publication
(10) Pub. No.: US 2026/0199845 A1
(43) Pub. Date: Jul. 16, 2026

(54) SYSTEM AND METHOD FOR PRODUCING A COLORING AND FLAVORING SOLUTION

(71) Applicant: STRATUMTEC SPOLKA Z OGRANICOZONA ODPOWIEDZIALNOSCIA, Warka (PL)

(72) Inventor: Mateusz KOC, Warka (PL)

(21) Appl. No.: 19/247,405

(22) Filed: Jun. 24, 2025

(30) Foreign Application Priority Data
Jan. 13, 2025 (PL) P.450943

(51) Int. Cl. B01F 23/237; A23B 4/048; A23L 5/42; B01F 23/23; B01F 35/221; B01F 101/06

(52) U.S. Cl. CPC B01F 23/237611; A23B 4/048; A23L 5/42; B01F 23/2319; B01F 35/2213; B01F 2101/06; B01F 2215/0431; B01F 2215/045; B01F 2215/0468; B01F 2215/0472

(57) ABSTRACT

A system for producing a coloring and flavoring solution from a liquid coloring formulation comprises a pre-mixer (I) with a liquid coloring formulation inlet (1) and a compressed air inlet (2), and a pre-disintegrated mixture outlet (3) with a tubing (4), a disintegrating device (II) being a body (5) with a superheated steam inlet (6), a pre-disintegrated mixture inlet (7) supplied by a tubing (4) and a compressed air inlet (8), and a disintegrated mixture outlet (9) with a tubing (4′), and a final mixer (III) with a disintegrated mixture inlet (11) supplied by the tubing (4′), comprising a superheated steam inlet (12) and a disintegrated coloring and flavoring solution outlet (13).

A method for producing a coloring and flavoring solution from a liquid coloring formulation comprises steps in which:
a liquid coloring formulation and compressed air are fed into a pre-mixer to produce a pre-disintegrated mixture,
the resulting pre-disintegrated mixture is introduced into a disintegrating device through which superheated steam flows, where the compressed air is simultaneously fed for further mixing and disintegrating the particles of the coloring formulation, and further
the resulting finely disintegrated mixture is fed into a final mixer, in which the mixture is contacted for further disintegration with superheated steam supplied by the tubing,
   obtaining a coloring and flavoring solution at the outlet from the final mixer.

### FIELD OF THE INVENTION

The present invention relates to a system for producing a coloring and flavoring solution from a liquid coloring formulation, and a method for producing a coloring and flavoring solution for food.

The invention is broadly used in the food industry, especially in the smoke industry. The invention is applicable to the coloring and smoking of food, aims at preserving and enhancing the visual and taste values of food products, in particular meat formulations, cheeses and fish.

### BACKGROUND ART

Smoking, in addition to salting and drying, is the basic method of preserving food, while giving it aesthetic values by coloring the surface, and taste values by flavoring. Smoking is generally accomplished by exposing the food product in the smoking chamber to a coloring and flavoring solution, e.g., smoke, water-soluble flavors, or browning agents.

Publication FR-A-2201038 describes the process of smoking food products, in which a processing medium (air) circulates in the smoking chamber, into which liquid smoke droplets are introduced during circulation, with the smoke droplets evaporating on the heated surface.

Publication DE-A-4234656 describes a smoking process in which liquid smoke is sprayed directly into the fan inlet nozzle by means of which the processing medium circulates in the processing chamber.

Publication WO2023136770, in turn, discloses a smoke generator comprising a housing with a condensate inlet for receiving the smoke condensate and a steam inlet for receiving the superheated steam, wherein the smoke condensate is converted to smoke particles when the smoke condensate interacts with the superheated steam and the smoke particles are present at the smoke outlet. This publication also discloses a system for supplying smoke particles to a smoke chamber, comprising a smoke generator, a steam supply and a smoke condensate supply, wherein the steam supply supplies superheated steam to the smoke generator via a pressure regulator, and the smoke condensate supply supplies the smoke condensate to the smoke generator via a condensate regulator, wherein the smoke particles from the smoke outlet of the smoke generator are provided to the smoke chamber inlet. The generator is equipped with a nozzle designed to distribute smoke condensate inside the smoke generator housing. To ensure the continuity of the process, the smoke condensate distributing nozzle must be located at a distance from both the smoke outlet and the of the housing walls and the steam inlet, which prevents the apparatus from clogging due to insufficient disintegration of the smoke particles.

Known processes do not ensure uniformity, quality and durability of the coloring, and sometimes also the taste of the products. In the described processes, the smoke particles are not sufficiently disintegrated and homogeneous to ensure deep penetration of the food, i.e. penetration into the deep layers of the food product and to ensure uniform coloring of the entire surface of the food product, free of stains. A common feature of the known processes is that the total time for performing the step of smoking food with a coloring and flavoring solution, e.g. smoke, water-soluble flavors, browning agents, is relatively long and amounts to 7-60 minutes. A disadvantage of the devices used so far are also the design requirements relating to ensuring minimum distances between the inlets of mixed fractions in order to prevent them from sealing and clogging.

### PROBLEM TO BE SOLVED

There is a need to improve the process of smoking and coloring the food products, in particular by providing a simple system and method for producing a coloring and flavoring solution with micrometric particle fineness of the coloring formulation, which will allow easier covering of the food product and deeper penetration into its structure. The present invention addresses the existing technological problems by significantly shortening the time of food penetration by the particles of the coloring formulation as a result of their considerable and at the same time even disintegration. The system according to the invention solves problems related to clogging and sealing of mixed fraction inlets, as its design ensures patency at each step, with many times faster flows.

### SUMMARY OF THE INVENTION

The subject of the invention is a system for producing a coloring and flavoring solution from a liquid coloring formulation comprising a mixer into which a coloring formulation and a stream of compressed air for mixing thereof are introduced, characterized in that it comprises
a pre-mixer that has a liquid coloring agent inlet and a compressed air inlet, and a pre-disintegrated mixture outlet with a tubing,
a disintegrating device comprising a body with a superheated steam inlet, a pre-disintegrated mixture inlet supplied through the tubing and a compressed air inlet, and a disintegrated mixture outlet with a tubing, and
a final mixer with a disintegrated mixture inlet supplied through the tubing, having

a superheated steam inlet and a disintegrated coloring and flavoring solution outlet.

Preferably, the system according to the invention comprises a control device for controlling compressed air pressure supplied to the pre-mixer and to the disintegrating device, and for controlling superheated steam pressure supplied to the disintegrating device and/or to the final mixer. The control is preferably performed by adjusting the parameters on solenoid valves.

The pre-mixer preferably is a tee with the liquid coloring formulation inlet on one side, the compressed air inlet on the other side, and the pre-disintegrated mixture outlet connected to the tubing.

In a preferred embodiment of the invention, the body of the disintegrating device has:
the superheated steam inlet oriented according to the longitudinal axis of the body,
the pre-disintegrated mixture inlet oriented with respect to the longitudinal axis of the body at an angle in the range of 10-90 degrees,
the compressed air inlet oriented with respect to the longitudinal axis of the body at an angle in the range of 30-90 degrees, and
the disintegrated mixture outlet oriented according to the longitudinal axis of the body.

Preferably, the body of the disintegrating device is a pipe with an inner diameter equal to the diameter of the superheated steam inlet.

In another preferred variant of the system of the invention, the body of the disintegrating device has the inner diameter larger than the diameter of the superheated steam inlet. The body of the disintegrating device then preferably has a circular or polygonal cross-section and is terminated on both opposite sides with funnel-shaped walls, wherein the funnel-shaped inlet wall is connected to the superheated steam inlet, and the funnel-shaped outlet wall is connected to the disintegrated mixture outlet. The pre-disintegrated mixture inlet is disposed on the funnel-shaped inlet wall and the compressed air inlet is disposed on the peripheral portion of the body. Preferably, the pre-disintegrated mixture inlet is disposed on the funnel-shaped inlet wall at a distance from the superheated steam inlet in the range of 0.1-90 mm, and/or at a distance from the peripheral portion of the body in the range of 0.01-40 mm. The shape of the funnel-shaped wall may be conical or rounded. The pre-disintegrated mixture inlet is then connected to the body at an angle with respect to the longitudinal axis of the body in the range of 10-80 degrees, preferably 30-50 degrees.

Preferably, the body of the disintegrating device has an inner diameter in the range of 10-300 mm. Preferably, the pre-disintegrated mixture inlet has an inner diameter in the range of 6-12 mm, the superheated steam inlet has a diameter in the range of 10-50 mm, and the disintegrated mixture outlet has a diameter in the range of 10-40 mm.

Preferably, in the disintegrating device, the pre-disintegrated mixture inlet and the compressed air inlet are spaced apart by a distance in the range of 100-1000 mm.

In the system according to the invention, preferably the final mixer is a tee.

The subject of the invention is also a method for producing a coloring and flavoring solution from a liquid coloring formulation, characterized in that it comprises steps in which:
I. a liquid coloring formulation and compressed air are fed into a pre-mixer to produce a pre-disintegrated mixture,
II. the resulting pre-disintegrated mixture is introduced into a disintegrating device through which superheated steam flows, where the compressed air is simultaneously fed for further mixing and disintegrating the particles of the coloring formulation, and further
III. the resulting finely disintegrated mixture is fed into a final mixer, in which the mixture is contacted for further disintegration with superheated steam supplied by the tubing,
   obtaining a coloring and flavoring solution at the outlet from the final mixer.

Preferably, the method of the invention is implemented in the system described above.

Preferably, in step I, the liquid coloring agent is fed into the pre-mixer and compressed air is fed at a pressure in the range of 0.10-6.0 bar (10-600 kPa), in step II, superheated steam is fed into the disintegrating device at a pressure in the range of 1.8-3.5 bar (180-350 kPa) and compressed air is fed at a pressure in the range of 0.1-6.0 bar (10-600 kPa), then in step III, superheated steam is fed into the final mixer at a pressure in the range of 1.8-3.5 bar (180-350 kPa). In step II and step III, steam having a temperature in the range of 130-160° C., preferably in the range of 140-160° C., is fed.

Preferably, by means of a control device for controlling compressed air pressure at the inlet to the pre-mixer, the outflow of the liquid coloring formulation is set above 30 L/h, preferably in the range of 30-360 L/h.

The method of the invention provides a coloring and flavoring solution with a particle fineness of the coloring agent in the range of 0.1-3.9 μm.

The coloring and flavoring solution thus obtained is introduced into a smoking chamber, a brewing chamber or an oven.

The system of the invention allows for obtaining a coloring and flavoring solution with a particle fineness of the coloring agent of the order of even a fraction of a micrometer, regardless of the use or absence of a spray nozzle in the pre-mixer and/or the disintegrating device and/or the final mixer. This indicates the high versatility of the designed system.

### DESCRIPTION OF DRAWINGS

The subject of the invention is presented in its embodiments in the drawing, wherein:

FIG. 1 shows a block diagram of a system for producing a coloring and flavoring solution from a liquid coloring formulation,

FIGS. 2A and 2B show examples of a pre-mixer,

FIG. 3 shows an example of a disintegrating device,

FIG. 4 shows another example of the disintegrating device,

FIG. 5 shows a section of the disintegrating device of FIG. 4,

FIGS. 6A, 6B, 6C and 6D show exemplary cross-sections of a disintegrating device body,

FIG. 7 shows a fragment of the exemplary system of the invention, comprising the disintegrating device and a final mixer,

FIG. 8 shows a fragment of another exemplary system of the invention, comprising the disintegrating device and the final mixer,

FIGS. 9A and 9B show examples of the final mixer,

FIG. 10 shows an exemplary system of the invention.

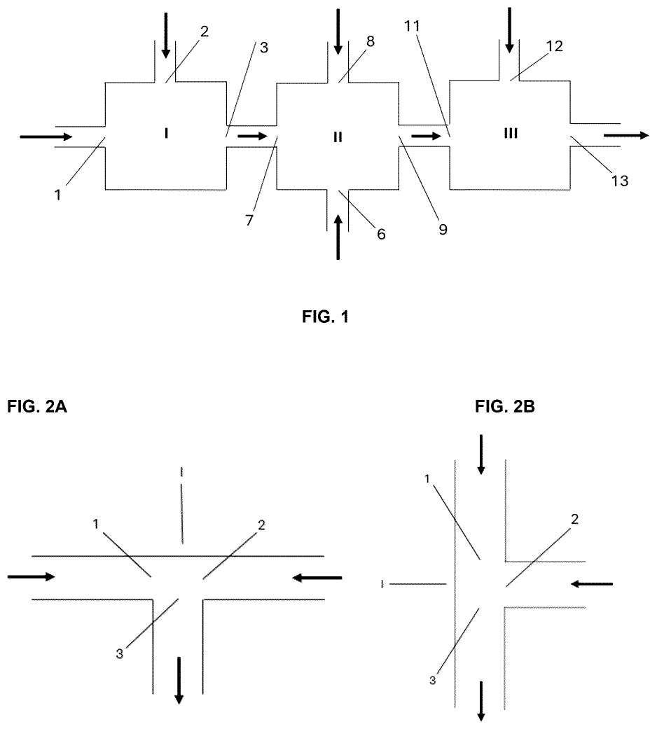

The system of the invention shown schematically in FIG. 1 comprises a pre-mixer I with a liquid coloring formulation inlet 1 and a compressed air inlet 2, and a pre-disintegrated mixture outlet 3, a disintegrating device II with a superheated steam inlet 6, a pre-disintegrated mixture inlet 7 and a compressed air inlet 8, and a disintegrated mixture outlet 9, and a final mixer III with a disintegrated mixture inlet 11, a superheated steam inlet 12 and a disintegrated coloring and flavoring solution outlet 13.

The embodiment of two variants 2A and 2B of the pre-mixer I shown in FIG. 2 is a tee with the liquid coloring formulation inlet 1 and the compressed air inlet 2, and the pre-disintegrated mixture outlet 3.

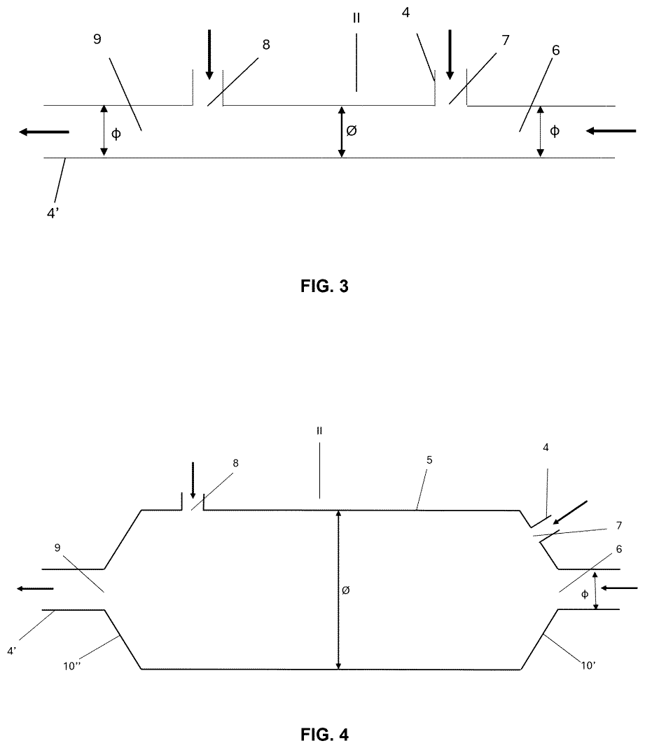

FIG. 3 shows an embodiment of a disintegrating device (II) with an inner diameter Φ of the tubular body 5 equal to the diameter φ of the superheated steam inlet 6, wherein the pre-disintegrated mixture inlet 7 from the pre-mixer I is perpendicular to the longitudinal axis of the tubular body 5 and the compressed air inlet 8 is perpendicular to the longitudinal axis of the tubular body 5. The inner diameter Φ of the tubular body 5 is also equal to the diameter φ of the disintegrated mixture outlet 9.

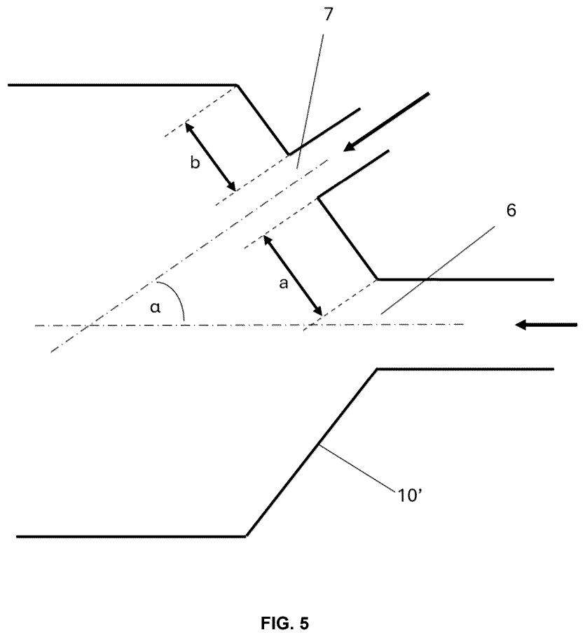

FIG. 4 shows an embodiment of the disintegrating device II, wherein the peripheral portion of the body (5) is a cylinder with an inner diameter Φ greater than the diameter φ of the superheated steam inlet 6, wherein the body 5 is terminated on both opposite sides by funnel-shaped walls (10′, 10″), respectively connected to the superheated steam inlet (6) and the disintegrated mixture outlet (9). Further, the pre-disintegrated mixture inlet (7) is provided on the funnel-shaped inlet wall 10′ and the compressed air inlet 8 is provided on the peripheral portion of the body 5.

The enlarged view of the disintegrating device of FIG. 4 presented in FIG. 5 shows the pre-disintegrated mixture inlet 7 located on the funnel-shaped inlet wall 10′ at a distance a from the superheated steam inlet 6 and at a distance b from the peripheral portion of the body. The pre-disintegrated mixture inlet (7) is oriented at an angle α with respect to the longitudinal axis of the body.

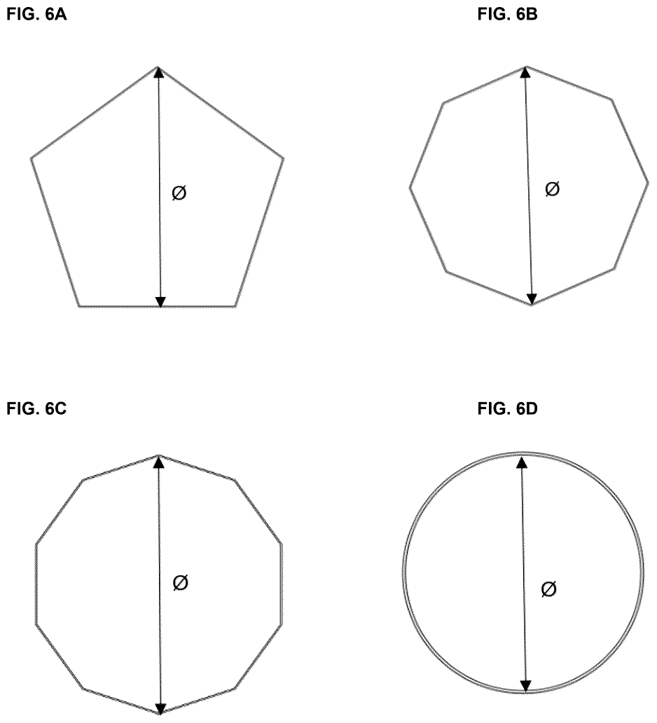

FIG. 6 shows exemplary cross-sections of the disintegrating device body, including pentagonal (FIG. 6A), circular (FIG. 6D), and in the shape of any polygon (FIG. 6B and C).

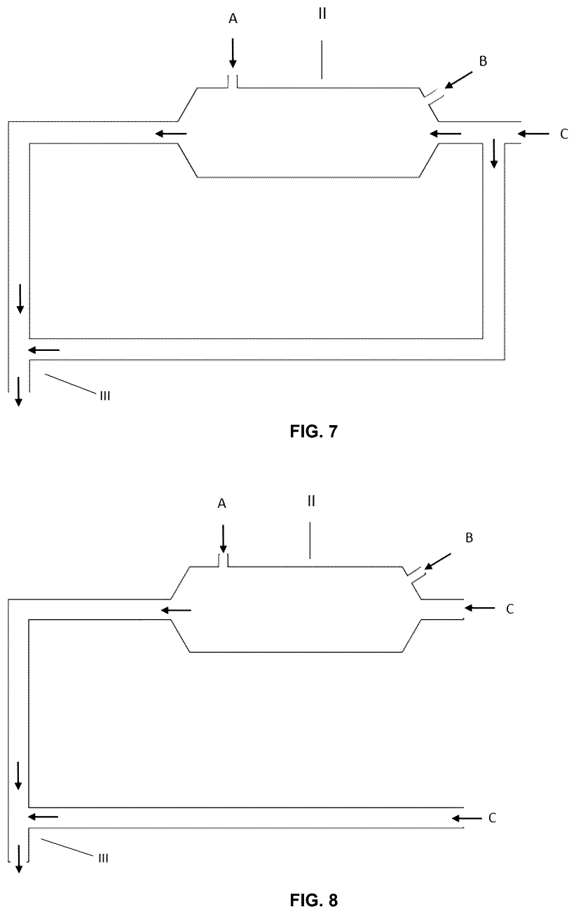

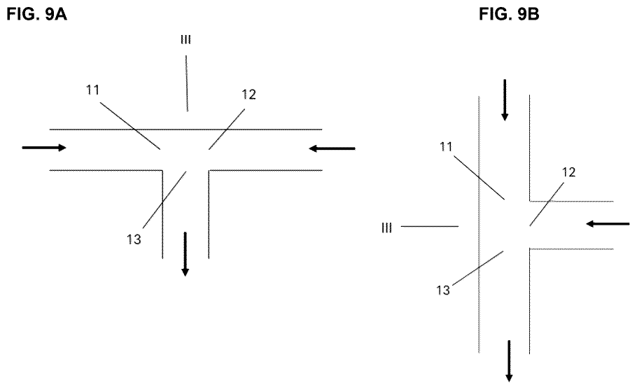

FIG. 7 shows a fragment of an exemplary system of the invention, comprising the disintegrating device II of FIG. 4 and the final mixer III of FIG. 9B, wherein the disintegrating device II and the final mixer III are fed with superheated steam from a single source.

FIG. 8 shows a fragment of the exemplary system, comprising the disintegrating device II of FIG. 4 and the final mixer III of FIG. 9B, wherein the disintegrating device II and the final mixer III are fed with superheated steam from two independent sources.

FIG. 9 shows exemplary embodiments of two variants (9A and 9B) of the final mixer III in the form of a tee with the disintegrated mixture inlet 11 from the intermediate mixer II, the superheated steam inlet 12, and the disintegrated coloring and flavoring solution outlet 13.

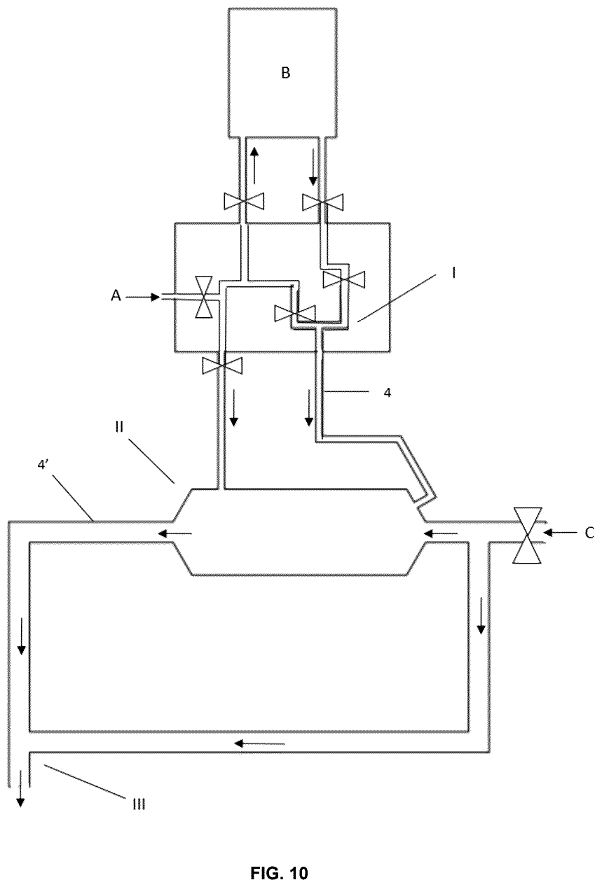

FIG. 10 shows an exemplary system of the invention, in which a source of compressed air A is connected tubularly to a tank with a liquid coloring formulation B, allowing the coloring formulation to be pumped with compressed air to the pre-mixer I acting as a pre-disintegrating device. The pre-mixer I is in the form of a tee, with the second inlet connected to a source of compressed air A. The pre-mixer I outlet is connected to the disintegrating device II by a tubing 4 leading to the inlet 7 in the funnel-shaped inlet wall of the disintegrating device body 5 as shown in FIG. 5. The diameter of the peripheral portion of the body of the disintegrating device II is greater than the diameter of the superheated steam C inlet, oriented longitudinally with respect to the axis of the body. The compressed air inlet is connected perpendicularly to the peripheral portion of the body. The disintegrated mixture outlet from the disintegrating device (II) is located at the end of the funnel-shaped outlet wall, on the outlet side of the body. The disintegrating device (II) outlet is connected by a tubing 4′ to a tee of the final mixer III, the second inlet of which is connected by a tubing to the source of superheated steam C. The final mixer III outlet is the outlet of the final product—a disintegrated coloring and flavoring solution. At the inlets to the mixers (I, III) and the disintegrating device (II) there are solenoid valves controlled by the control device, regulating the flows in the system.

### EXAMPLES OF EMBODIMENTS

### Example 1

A system consists of a tee-shaped pre-mixer, with one inlet connected to a tank of a liquid coloring formulation and the second inlet connected to a source of compressed air as in FIG. 2B. The pre-mixer outlet is tubularly connected to a disintegrating device inlet oriented perpendicularly to a pipe of the disintegrating device having a diameter of Φ=50 mm, longitudinally connected to a superheated steam source through an inlet having a diameter of φ=50 mm as shown in FIG. 3. The disintegrating device outlet having a diameter of φ=50 mm is connected to a tee constituting the final mixer, the second inlet of which is connected to the same source of superheated steam. The outlet from the last tee is the outlet of the final product.

### Example 2

The method was implemented in the system of Example 1.

The liquid coloring formulation at a speed of 35 l/h, and compressed air at a pressure of 3 bar, were fed through tubing into the pre-mixer (I) in the form of the tee to produce a pre-disintegrated mixture. The pre-disintegrated mixture was introduced into the disintegrating device in the form of the pipe through which superheated steam with a temperature of 140° C. was flowing at a pressure of 1.8 bar (180 kPa). Compressed air was introduced into the disintegrating device by means of the perpendicular pipe at a pressure of 3 bar (300 kPa). The disintegrated mixture on the outlet of the disintegrating device was brought by a tubing to the final mixer in the form of a tee. To the second arm of the tee superheated steam was directed from the same source, at a pressure of 1.8 bar (180 kPa), producing at the outlet from the final mixer a ready-for-use coloring and flavoring solution, with a particle fineness of the coloring agent in the range of 0.1-3.9 μm.

### Example 3

The system consists of a tee-shaped pre-mixer, with one inlet connected to the tank of the liquid coloring formulation and the second inlet connected to the source of compressed air. The pre-mixer outlet is tubularly connected to the disintegrating device inlet having a cross-section of φ=12 mm, located on the funnel-shaped inlet wall of the disintegrating device body with an octahedron shape with a cross-section diameter of Φ=210 mm (FIG. 6B). The axially oriented superheated steam inlet has a diameter of φ=40 mm. The distance between the pre-mixer inlet and the superheated steam inlet on the funnel-shaped inlet wall of the disintegrating device is equal to a=40 mm. The disintegrating device outlet located on the funnel-shaped outlet wall of the disintegrating device has a diameter of φ=40 mm and is tubularly connected to the tee being a final mixer, the second inlet of which is connected to a further source of superheated steam as shown in FIG. 9. The outlet from the last tee is the outlet of the final product.

### Example 4

The method was implemented in the system of Example 3.

The liquid coloring formulation at a speed of 210 l/h and compressed air at a pressure of 5.5 bar (550 kPa), were fed through tubing into the pre-mixer in the form of a tee to produce a pre-disintegrated mixture. The pre-disintegrated mixture was introduced into the disintegrating device in the form of an octahedron terminated with funnel-shaped inlet and outlet walls through which superheated steam with a temperature of 150° C. was flowing at a pressure of 3 bar (300 kPa). Compressed air was introduced into the disintegrating device by means of the perpendicular pipe at a pressure of 5.5 bar (550 kPa). The disintegrated mixture on the outlet of the disintegrating device was brought by a tubing to the final mixer in the form of a tee, to the second arm of which a superheated steam was directed at a pressure of 3 bar (300 kPa), obtaining at the outlet from the final mixer the ready-for-use coloring and flavoring solution, with a particle fineness of the coloring agent in the range of 0.1-3.9 μm.

### Example 5

The system consists of a tee-shaped pre-mixer, with one inlet connected to the tank of the liquid coloring formulation and the second inlet connected to the source of compressed air. The pre-mixer outlet is tubularly connected to the disintegrating device inlet with a cross-section of φ=8 mm, located on the funnel-shaped inlet wall of the disintegrating device body with a cylindrical shape with a cross-section diameter of Φ=170 mm (FIG. 6D). The axially oriented superheated steam inlet has a diameter of φ=30 mm. The distance between the pre-mixer inlet and the superheated steam inlet on the funnel-shaped inlet wall of the disintegrating device is equal to a=30 mm. The disintegrating device outlet located on its funnel-shaped outlet wall has a diameter of φ=30 mm and is tubularly connected to the tee ofthe final mixer, the second inlet of which is connected to the same source of superheated steam as shown in FIG. 8. The outlet from the last tee is the outlet of the final product.

### Example 6

The method was implemented in the system of Example 5.

The liquid coloring formulation at a speed of 70 l/h and compressed air at a pressure of 4.5 bar, were fed through tubing into the pre-mixer in the form of a tee, to produce a pre-disintegrated mixture. The pre-disintegrated mixture was introduced into the disintegrating device having a cylindrical shape through which superheated steam with a temperature of 150° C. was flowing at a pressure of 2.2 bar (220 kPa). Compressed air was introduced into the disintegrating device with a perpendicular pipe at a pressure of 4.5 bar (450 kPa). The disintegrated mixture on the outlet of the disintegrating device was brought by a tubing to the final mixer in the form of a tee, to the second arm of which a superheated steam was directed at a pressure of 2.2 bar (220 kPa), obtaining at the outlet from the final mixer tee the ready-for-use coloring and flavoring solution, with a particle fineness of the coloring agent in the range of 0.1-3.9 μm.

### ADVANTAGES

The described system and method according to the invention provides a simple and easy-to-implement process for the three-step disintegration of coloring agent particles for coloring and smoking food products. While the disintegrating device allows to achieve the initial particle fineness of the coloring agent in the range of 4-7 μm, the simple construction final mixer used in the system according to the invention allows to achieve the particle fineness of the coloring agent in the range of 0.1-3.9 μm. The phenomenon of clogging and sealing of the inlets of mixed fractions is eliminated, as the design of the system ensures patency at each step, with many times faster flows. In addition, the micrometric particle fragmentation of the coloring agent allows the food coloring step to be completed in a much shorter time, on the order of 0.5-16 minutes.

### REFERENCE NUMBERS

I—pre-mixer
II—disintegrating device
III—final mixer
1—liquid coloring formulation inlet
2—compressed air inlet
3—pre-disintegrated mixture outlet
4, 4′—tubing
5—disintegrating device body
6—superheated steam inlet
7—pre-disintegrated mixture inlet
8—compressed air inlet
9—disintegrated mixture outlet
10′—funnel-shaped inlet wall
10″—funnel-shaped outlet wall
11—disintegrated mixture inlet
12—superheated steam inlet
13—disintegrated coloring and flavoring solution outlet
Φ—inner diameter of the body
φ—diameter of inlets and outlets
a—distance between the inlet 7 and the inlet 6
b—distance between the inlet 7 and the peripheral portion of the body
α—inlet 7 inclination angle with respect to the longitudinal axis of the body
A—compressed air
B—liquid coloring formulation
C—superheated steam

1. A system for producing a coloring and flavoring solution from a liquid coloring formulation, the system comprising a mixer into which a coloring formulation and a stream of compressed air for mixing thereof are introduced, characterized in that it comprises
a pre-mixer (I) with a liquid coloring formulation inlet (1) and a compressed air inlet (2), and a pre-disintegrated mixture outlet (3) with a tubing (4),
a disintegrating device (II) comprising a body (5) with a superheated steam inlet (6), a pre-disintegrated mixture inlet (7) supplied through the tubing (4) and a compressed air inlet (8), and a disintegrated mixture outlet (9) with a tubing (4′), and
a final mixer (III) with a disintegrated mixture inlet (11) fed through the tubing (4′), having a superheated steam inlet (12) and a disintegrated coloring and flavoring solution outlet (13).

2. The system according to claim 1, characterized in that it comprises a control device for controlling compressed air pressure supplied to the pre-mixer (I) and to the disintegrating device (II), and for controlling superheated steam pressure supplied to the disintegrating device (II) and/or to the final mixer (III).

3. The system according to claim 1, characterized in that the pre-mixer (I) is a tee with the liquid coloring formulation inlet (1) on one side, the compressed air inlet (2) on the other side, and the pre-disintegrated mixture outlet (3) connected to the tubing (4).

4. The system according to claim 1, characterized in that the disintegrating device (II) body (5) comprises:
the superheated steam inlet (6) oriented according to the longitudinal axis of the body (5),
the pre-disintegrated mixture inlet (7) oriented with respect to the longitudinal axis of the body (5) at an angle in the range of 10-90 degrees,
the compressed air inlet (8) oriented with respect to the longitudinal axis of the body at an angle in the range of 30-90 degrees, and
the disintegrated mixture outlet (9) oriented according to the longitudinal axis of the body (5).

5. The system according to claim 4, characterized in that the body (5) of the disintegrating device (II) is a pipe with an inner diameter (Φ) equal to the diameter (φ) of the superheated steam inlet (6).

6. The system according to claim 4, characterized in that the body (5) of the disintegrating device (II) is a pipe with an inner diameter (Φ) larger than the diameter (φ) of the superheated steam inlet (6).

7. The system according to claim 6, characterized in that the body (5) of the disintegrating device (II) has a circular or polygonal cross-section.

8. The system according to claim 6, characterized in that the body (5) of the disintegrating device (II) is terminated on both opposite sides with funnel-shaped walls (10′, 10″), wherein the funnel-shaped inlet wall (10′) is connected to the superheated steam inlet (6) and the funnel-shaped outlet wall (10″) is connected to the disintegrated mixture outlet (9).

9. The system according to claim 8, characterized in that the pre-disintegrated mixture inlet (7) is disposed on the funnel-shaped inlet wall (10′) and the compressed air inlet (8) is disposed on the peripheral portion of the disintegrating device body (5).

10. The system according to claim 9, characterized in that the pre-disintegrated mixture inlet (7) is disposed on the funnel-shaped inlet wall (10′) at a distance (a) from the superheated steam inlet (6) in the range of 0.1-90 mm, and/or at a distance (b) from the peripheral portion of the body in the range of 0.01-40 mm.

11. The system according to claim 9, characterized in that the pre-disintegrated mixture inlet (7) is connected to the body (5) at an angle with respect to the longitudinal axis of the body in the range of 10-80 degrees, preferably 30-50 degrees.

12. The system according to claim 1, characterized in that the disintegrating device (II) body (5) has an inner diameter (Φ) in the range of 10-300 mm, the pre-disintegrated mixture inlet (7) has an inner diameter in the range of 6-12 mm, the superheated steam inlet (6) has a diameter in the range of 10-50 mm, and the disintegrated mixture outlet (9) has a diameter in the range of 10-40 mm.

13. The system according to claim 1, characterized in that the pre-disintegrated mixture inlet (7) and the compressed air inlet (8) are spaced apart by a distance in the range of 100-1000 mm.

14. The system according to claim 1, characterized in that the final mixer (III) is a tee.

15. A method for producing a coloring and flavoring solution from a liquid coloring formulation, characterized in that it comprises steps in which:
I. a liquid coloring formulation and compressed air are fed into a pre-mixer to produce a pre-disintegrated mixture,
II. the resulting pre-disintegrated mixture is introduced into a disintegrating device through which superheated steam flows, to which the compressed air is simultaneously fed for further mixing and disintegrating the particles of the coloring formulation, and further
III. the resulting finely disintegrated mixture is fed into a final mixer, in which the mixture is contacted for further disintegration with superheated steam supplied by the tubing,
for obtaining the coloring and flavoring solution at the outlet from the final mixer.

16. The method according to claim 15, characterized in that it is implemented in the system for producing a coloring and flavoring solution from a liquid coloring formulation, the system comprising a mixer into which a coloring formulation and a stream of compressed air for mixing thereof are introduced, characterized in that it comprises
a pre-mixer (I) with a liquid coloring formulation inlet (1) and a compressed air inlet (2), and a pre-disintegrated mixture outlet (3) with a tubing (4),
a disintegrating device (II) comprising a body (5) with a superheated steam inlet (6), a pre-disintegrated mixture inlet (7) supplied through the tubing (4) and a compressed air inlet (8), and a disintegrated mixture outlet (9) with a tubing (4′), and
a final mixer (III) with a disintegrated mixture inlet (11) fed through the tubing (4′), having a superheated steam inlet (12) and a disintegrated coloring and flavoring solution outlet (13).

17. The method according to claim 15, characterized in that in step I, the liquid coloring formulation is fed into the pre-mixer (I) and compressed air is fed at a pressure in the range of 0.10-6.0 bar (10-600 kPa), in step II, the superheated steam is fed into the disintegrating device (II) at a pressure in the range of 1.8-3.5 bar (180-350 kPa) and the compressed air is fed at a pressure in the range of 0.1-6.0 bar (10-600 kPa), then in step III, the superheated steam is fed into the final mixer (III) at a pressure in the range of 1.8-3.5 bar (180-350 kPa).

18. The method according to claim 15, characterized in that in step II and step III, the steam having a temperature in the range of 130-160° C., preferably in the range of 140-160° C., is fed.

19. The method according to claim 15, characterized in that by means of a control device for controlling compressed air pressure at the inlet to the pre-mixer (I), the outflow of the liquid coloring formulation is set at 30 L/h and higher, preferably in the range of 30-360 L/h.

20. The method according to claim 15, characterized in that it provides the coloring and flavoring solution with a particle fineness of the coloring agent in the range of 0.1-3.9 μm.
